(19) United States
(12) Patent Application Publication
(10) Pub. No.: US 2024/0246533 A1
(43) Pub. Date: Jul. 25, 2024

(54) METHOD AND DEVICE FOR ASCERTAINING AN ACCELERATION PREVAILING IN A VEHICLE

(71) Applicant: Robert Bosch GmbH, Stuttgart (DE)

(72) Inventors: Gunther Lang, Stuttgart (DE); Marc Teufel, Ditzingen (DE); Simon Koenig, Moeckmuehl (DE)

(21) Appl. No.: 18/538,195

(22) Filed: Dec. 13, 2023

(30) Foreign Application Priority Data
Jan. 23, 2023 (DE) 10 2023 200 479.8

(51) Int. Cl. B60W 30/095

(52) U.S. Cl. CPC B60W 30/0953

(57) ABSTRACT

A method for ascertaining an acceleration prevailing in a vehicle. The method includes reading in a first input signal which represents a first acceleration acting transversely to the vehicle axis at a first location located on a vehicle axis in the vehicle, and a second input signal which represents a second acceleration acting transversely to the vehicle axis at a second location in the vehicle located on the vehicle axis, and an ascertainment of an output signal which represents a translational acceleration acting in the vehicle transversely to the vehicle axis at a position which differs from the first location and the second location. For this purpose, the input signals and distances along the vehicle axis between the locations and the position are used.

### CROSS REFERENCE

The present application claims the benefit under 35 U.S.C. § 119 of German Patent Application No. DE 10 2023 200 479.8 filed on Jan. 23, 2023, which is expressly incorporated herein by reference in its entirety.

### FIELD

The present invention relates to a device and a method for ascertaining an acceleration prevailing in a vehicle. The present invention also relates to a computer program.

### BACKGROUND INFORMATION

Vehicle collisions are recognized by evaluating signals from acceleration sensors: on the one hand, a central sensor system (measuring in the longitudinal (x) and lateral (y) directions) is located in the airbag controller, which is usually mounted centrally in the vehicle on the center tunnel; on the other hand, external acceleration sensors, which can measure in the x and/or y directions, are located on the vehicle periphery.

German Patent Application No. DE 10 2021 207 974 A1 DE describes a detection of off-zone crashes in which a vehicle is involved, by using lateral acceleration values which are detected at positions within the vehicle.

### SUMMARY

The present invention provides a method for ascertaining an acceleration prevailing in a vehicle, in addition, a device that uses this method, and finally a corresponding computer program. Advantageous developments and improvements of the device according to the present invention are made possible by the measures disclosed herein.

The present invention makes it possible to reconstruct acceleration signals, in particular translational accelerations, at locations without sensors.

According to an example embodiment of the present invention, a method for ascertaining an acceleration prevailing in a vehicle comprises the following steps:
Reading in a first input signal which represents a first acceleration which is acting transversely to the vehicle axis at a first location located on a vehicle axis in the vehicle, and a second input signal which represents a second acceleration which is acting transversely to the vehicle axis at a second location located on the vehicle axis in the vehicle; and
Ascertaining an output signal that represents a translational acceleration which is acting transversely to the vehicle axis at a position in the vehicle that differs from the first location and the second location, by using the first input signal, the second input signal, a first distance along the vehicle axis between the first location and the position and a second distance along the vehicle axis between the second location and the position.

The vehicle can be a road vehicle, for example a passenger car. The method makes it possible to ascertain a translational acceleration at a position in the vehicle at which no acceleration sensor is located. The translational acceleration at this position can be ascertained by accelerations prevailing at at least two other locations in the vehicle. The two other locations lie on a vehicle axis, for example a longitudinal axis or a transverse axis of the vehicle, or on another straight line running through the vehicle. On the input side, accelerations can flow into the method which have a direction running transversely to the vehicle axis. The acceleration to be ascertained can also be a translational acceleration which has a direction running transversely to the vehicle axis. If the vehicle axis is a longitudinal axis of the vehicle, the accelerations ascertained on the input side will be lateral accelerations. If the vehicle axis is a transverse axis of the vehicle, the accelerations ascertained on the input side will be longitudinal accelerations. The distances mentioned here and below can be signed and can thus be understood to be direction-sensitive. For example, one of the distances can have a positive sign and the other of the distances can have a negative sign if the first location and the second location are located in relation to the position on different sides of the vehicle. A difference between the two distances can thus represent a distance between the first location and the second location.

According to an example embodiment of the present invention, the input-side accelerations can either be detected directly or determined, for example calculated. The input signals can thus be read in as electrical signals via interfaces to acceleration sensors or read in via an interface to a determination device. It is also possible to detect one of the input-side accelerations and to determine the other. A detected, for example measured, acceleration can comprise translational and rotational components. The output signals can be interpreted as purely translational if the axis of rotation is defined in this position, but does not have to be.

Accordingly, according to an example embodiment of the present invention, the method can comprise a step of detecting the first input signal by using a first acceleration sensor arranged at the first location. Additionally or alternatively, the method can comprise a step of detecting the second input signal by using a second acceleration sensor arranged at the second location. This is advantageous if at least one acceleration sensor is arranged on the relevant vehicle axis. Both input signals can thus either be detected or one of the input signals can be detected and the other of the input signals can be determined from further measurement signals.

According to an example embodiment of the present invention, additionally or alternatively, the method can comprise a step of determining the first input signal by using at least two first measurement signals which represent accelerations which in the vehicle are acting transversely to the vehicle axis at different first sensor locations located outside the vehicle axis. Additionally or alternatively, the method can comprise a step of determining the second input signal by using at least two second measurement signals which represent accelerations which in the vehicle are acting transversely to the vehicle axis at different second sensor locations located outside the vehicle axis. This is advantageous if there is no acceleration sensor or only one acceleration sensor is arranged on the relevant vehicle axis. In other words, either both input signals can be determined, or one of the input signals can be determined and the other of the input signals can be detected.

In the step of ascertaining, the output signal can be ascertained from a sum of the first acceleration multiplied by a first weighting factor and the second acceleration multiplied by a second weighting factor. The first weighting factor and the second weighting factor can thereby be determined by using the first distance and the second distance. Such an ascertainment can be carried out very quickly.

According to an example embodiment of the present invention, the first weighting factor can be determined as the quotient of the first distance and a difference between the first distance and the second distance. The second weighting factor can be determined as the quotient of the second distance and a difference between the first distance and the second distance. In this way, easily ascertained weighting factors can be used. The difference from the first distance can represent a distance between the first location and the second location.

In addition, according to an example embodiment of the present invention, in the step of ascertaining, a rotation signal can be ascertained, which represents a rotational acceleration which is acting at the position about an axis of rotation oriented orthogonally to the vehicle axis. The rotation signal can be ascertained by using the first input signal, the second input signal, the first distance and the second distance. As a result, accelerations acting at the position can be fully mapped.

For example, the rotation signal can be ascertained as a quotient of a difference from the second acceleration and the first acceleration as well as from a difference from the first distance and the second distance. The same input values can thus be used as for ascertaining the translational acceleration. According to one exemplary embodiment of the present invention, in the read-in step, a third input signal can be read in which represents a third acceleration, which at a third location in the vehicle, which third location in the vehicle is located on a further vehicle axis oriented orthogonally to the vehicle axis, is acting transversely to the further vehicle axis, and a fourth input signal is read in, which represents a fourth acceleration which, at a fourth location located on the further vehicle axis in the vehicle, is acting transversely to the further vehicle axis. In the step of ascertaining, a further output signal can be ascertained, which represents a translational acceleration which, at a further position in the vehicle which differs from the third location and the fourth location, is acting transversely to the further vehicle axis. The further output signal can be ascertained by using the third input signal, the fourth input signal, a third distance along the further vehicle axis between the third location and the further position and a fourth distance along the further vehicle axis between the fourth location and the further position. The further position can differ from the aforementioned position or the two positions can be identical. If the further vehicle axis is a transverse axis of the vehicle, the input-side and ascertained accelerations will be longitudinal accelerations. Not only lateral but also longitudinal accelerations can thus be ascertained for a position.

This method can be implemented, for example, in software or hardware or in a mixed form of software and hardware, for example in a control device.

The approach presented here further provides a device which is designed to carry out, actuate or implement the steps of a variant of a method presented here in corresponding apparatuses. The object of the present invention can also be achieved quickly and efficiently by this design variant of the present invention in the form of a device.

According to an example embodiment of the present invention, for this purpose, the device can have at least one computing unit for processing signals or data, at least one memory unit for storing signals or data, at least one interface to a sensor or an actuator for reading in sensor signals from the sensor or for outputting data signals or control signals to the actuator, and/or at least one communication interface for reading in or outputting data embedded in a communication protocol. The computing unit can, for example, be a signal processor, a microcontroller or the like, and the memory unit can be a flash memory or a magnetic memory unit. The communication interface can be designed to read in or output data in a wireless and/or wired manner, a communication interface, which can read in or output line-bound data, being able to read in these data, for example electrically or optically, from a corresponding data transmission line, or being able to output these data into a corresponding data transmission line.

A computer program product or a computer program with program code that can be stored on a machine-readable carrier or storage medium, such as a semiconductor memory, a hard disk memory, or an optical memory, and that is used for carrying out, implementing, and/or actuating the steps of the method according to one of the embodiments of the present invention described above is advantageous as well, in particular when the program product or program is executed on a computer or a device.

Exemplary embodiments of the present invention are illustrated in the figures and explained in more detail in the following description.

### BRIEF DESCRIPTION OF THE DRAWINGS

FIG. 1 shows a schematic representation of a vehicle with an exemplary embodiment of a device for ascertaining an acceleration, according to the present invention.

FIG. 2 shows a representation of accelerations in a vehicle according to an exemplary embodiment of the present invention.

FIG. 3 shows a schematic representation of an accident situation of a vehicle according to an exemplary embodiment of the present invention.

FIG. 4 shows a schematic representation of an accident situation of a vehicle according to an exemplary embodiment of the present invention.

FIG. 5 shows a schematic representation of an accident situation of a vehicle according to an exemplary embodiment of the present invention.

FIG. 6 shows a representation of a vehicle according to an exemplary embodiment of the present invention.

FIG. 7 shows a flowchart of a method according to an exemplary embodiment of the present invention.

### DETAILED DESCRIPTION OF EXAMPLE EMBODIMENTS

In the following description of advantageous exemplary embodiments of the present invention, the same or similar reference signs are used for the elements shown in the various figures and acting similarly, as a result of which a repeated description of these elements is omitted.

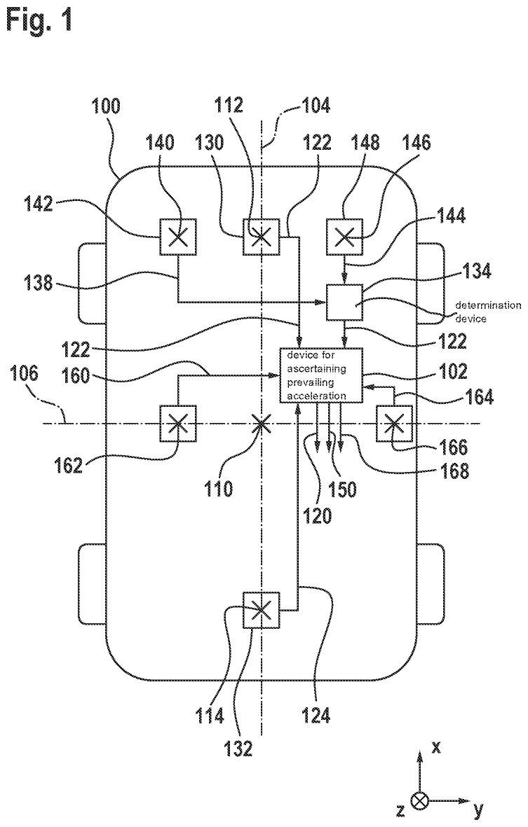

FIG. 1 shows a schematic representation of a vehicle 100 with an exemplary embodiment of a device 102 for ascertaining an acceleration prevailing in the vehicle 100.

In FIG. 1, a vehicle axis 104 and a further vehicle axis 106 are shown. Merely by way of example, the vehicle axis 104 is the longitudinal axis and the further vehicle axis 106 is the transverse axis of the vehicle 100. However, this assignment can also be reversed, or at least one of the axes can also run off-center. According to this exemplary embodiment, the vehicle axis 104 can also be referred to as the x-axis, the further vehicle axis 106 also as the y-axis and a vertical axis of the vehicle 100 also as the z-axis.

The device 102 is designed to ascertain an acceleration at a position 110 of the vehicle 100, at which, according to one exemplary embodiment, no acceleration sensor is arranged which would enable a direct detection of the acceleration at the position 110. The device 102 is designed to ascertain the translational acceleration at the position 110 by using accelerations which prevail at a first location 112 that differs from the position 110 and at a second location 114 that differs from the position 110.

The first location 112 and the second location 114 lie on one axis, here by way of example on the vehicle axis 104. The translational acceleration to be ascertained at the position 110
just like the accelerations at the first location 112 and the second location 114 used to ascertain this translational acceleration—is oriented transversely to the axis 104 on which the first location 112 and the second location 114 lie, in this case parallel to the transverse axis, i.e. laterally. The arrangement of the locations 112, 114 on both sides of the position 110 is merely exemplary. The two locations 112, 114 can also be located on the same vehicle side with respect to the position 110.

According to the exemplary embodiment shown, the position 110 likewise lies on the vehicle axis 104, but can also be arranged outside the vehicle axis 104.

According to an exemplary embodiment, the device 102 is designed to provide the translational acceleration ascertained at the position 110 by using an output signal 120. The acceleration acting at the first location 112 transversely to the vehicle axis 104 is read in by the device 102 by way of example by using a first input signal 122, and the acceleration acting at the second location 114 transversely to the vehicle axis 104 is read in by way of example by using a second input signal 124.

If a first acceleration sensor 130 is located at the first location 112, the acceleration prevailing at the first location 112 can be detected using the first acceleration sensor 130. In this case, the first acceleration sensor 130 is designed to supply the acceleration acting at the first location 112 to the device 102 in the form of the first input signal 122.

If a second acceleration sensor 132 is located at the second location 114, the acceleration prevailing at the second location 114 can be detected by using the second acceleration sensor 132. In this case, the second acceleration sensor 132 is designed to supply the acceleration acting at the second location 114 to the device 102 in the form of the second input signal 124.

If no suitable acceleration sensor is located at the first location 112, the acceleration prevailing at the first location 112 can be determined, for example calculated or estimated, using a determination device 134, and can be provided to the device 102 in the form of the first input signal 122. For example, the determination device 134 is designed to determine the first input signal 122 by using a first measurement signal 138 of a first alternative acceleration sensor 142 arranged at a first sensor location 140 and a second measurement signal 144 of a second alternative acceleration sensor 148 arranged at a second sensor location 146. According to an exemplary embodiment, the first sensor location 140 and the second sensor location 146 lie outside the vehicle axis 104. The first sensor location 140 and the second sensor location 146 are located on the same side as the first location 112 with respect to the position 110. In particular, the sensor locations 140 and 146 should be located on an axis transverse to the main axis 104 and passing through the first location 112.

In a corresponding manner, the acceleration prevailing at the second location 114 can be determined and provided to the device 102 in the form of the second input signal. For this purpose, the second input signal is determined, for example, by using a further first measurement signal of a first alternative acceleration sensor arranged at a further first sensor location and a further second measurement signal of a further second alternative acceleration sensor arranged at a further second sensor location. Here, the further first sensor location and the further second sensor location are located outside the vehicle axis 104. The further first sensor location and the further second sensor location are located with respect to the position 110 on the same side as the second location 114.

As will be explained in more detail below, the device 102 is designed to ascertain the output signal 120 by using the first input signal 122, the second input signal 124 along with a first distance along the vehicle axis 104 between the first location 112 and the position 110 and a second distance along the vehicle axis 104 between the second location 114 and the position 110.

According to one exemplary embodiment, the device 102 is further designed to ascertain a rotational acceleration with respect to the position 110 and to supply it in the form of a rotation signal 150, wherein the rotational acceleration acts on the axis of rotation, in this case the z-axis, oriented at the position 110 orthogonally to the vehicle axis 104. In this case, the device 102 is designed to ascertain the rotation signal 150 likewise by using the first input signal 122, the second input signal 124 along with the first distance mentioned and the second distance mentioned.

According to one exemplary embodiment, the device 102 is designed to ascertain, with respect to the position 110 or a further position different from the position 110, a translational acceleration which is oriented transversely to the further vehicle axis 106. For this purpose, the device 102 is designed to read in a third input signal 160 which represents a third acceleration which is acting transversely to the further vehicle axis 106 (i.e., longitudinally) at a third location 162 lying on the further vehicle axis 106, and to read in a fourth input signal 164 which represents a fourth acceleration which is acting transversely to the further vehicle axis 106 at a fourth location 166 lying on the further vehicle axis 106. The device 102 is designed to ascertain the translational acceleration acting here, for example, at the position 110 transversely to the further vehicle axis 106 by using the third input signal 160, the fourth input signal 164, a third distance along the further vehicle axis 106 between the third location 162 and the further position, here the position 110, and a fourth distance along the further vehicle axis 106 between the fourth location 166 and the further position, here the position 110, and to supply it in the form of a further output signal 168.

The output signals 120, 168 and the rotation signal can be used, for example, to recognize an accident, also referred to as a crash.

Crash recognition algorithms are based on processed sensor signals of these accelerations recorded at certain measurement locations.

Front crash recognition is based, for example, on the evaluation of the central x-signal, possibly supplemented by evaluations of the central y-signal, of the x-signals of so-called up-front sensors (UFS) mounted in the crumple zone, etc.

The acceleration-based side crash recognition is based on the evaluation of the sensors measuring in the y-direction mounted on the lateral vehicle periphery. Such so-called PAS sensors (peripheral acceleration sensors) can be mounted in a plurality of “axes,” e.g., on the A-pillar, B-pillar, C-pillar or laterally on the rear of the vehicle. In addition, the y-acceleration of the central control unit is evaluated.

On the other hand, rotational crash properties, such as occur, for example, in front crashes with partial overlapping (so-called offset crashes) or in side crashes with an impact point in front of or behind the passenger compartment (so-called side off-zone crashes), can be recognized by suitable comparisons or by formations of differences between different sensor signals. The recognition of a vehicle rotation on the basis of x-signals from peripheral sensors mounted on the left-hand and right-hand sides of the vehicle is possible for side crashes and for front crashes. The recognition of a vehicle rotation based on y-signals from sensors positioned at different positions along the vehicle longitudinal axis is also possible for side crashes and for front crashes.

With the approach described, the ascertainment of the accelerations prevailing in the central vehicle region is possible for vehicles in which no sensor system is available there, as in the case of the vehicle 100 shown. This applies, for example, to vehicles without a central control device or to vehicles having a control device that is not centrally seated. These accelerations are particularly important for a correct detection of vehicle crashes with rotational characteristics.

Advantageously, with the approach described here the vehicle 100 with no sensor system in the center of the vehicle can correctly and without difficulties recognize crashes with rotational characteristics. In particular, the lateral accelerations at the location of the occupants can be correctly detected, whereby a correct control of restraint means is possible. For example, for this purpose the position 110 can be moved to the location of an occupant.

The approach described makes it possible to reconstruct the acceleration signal, for example the output signal 120, at a location such as the position 110, which does not coincide with the locations 112, 114 at which the acceleration sensors 130, 132 are mounted. Such a location can be, for example, the center of gravity of the vehicle, a position of the front occupants or a position of the rear occupants. For this purpose, at least two sensors 130, 132 mounted at other locations 112, 114 are required. In this case, the rotational crash properties are not necessarily to be extracted, but rather the total acceleration is to be ascertained at a location such as the position 110.

In particular for vehicles in which the central control device is not mounted on the tunnel between the front occupants, but rather, for example, far forward on the bulkhead toward the engine compartment or at other non-central locations, or for vehicles without a central sensor system, the method described here makes it possible to reconstruct the acceleration which prevails at the vehicle center of gravity, for example, and thus to enable better crash recognition and also the reconstruction of the accelerations prevailing at the location of the occupants, and thus to enable a control of the restraint means better matched to the occupants. This can optionally also take place separately for the front and rear occupants.

The described approach can also be advantageous for BEV vehicles without a central tunnel, in which the control unit can be installed at other non-central positions.

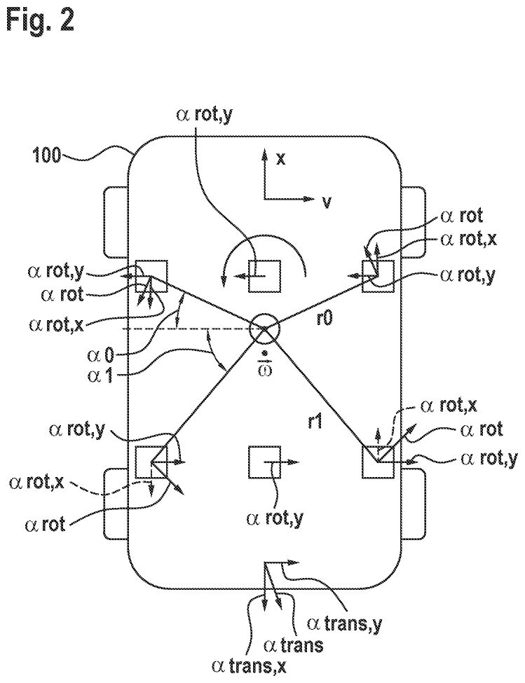

FIG. 2 shows a representation of accelerations on a vehicle 100 according to an exemplary embodiment. In particular, rotational accelerations at peripheral sensors and at central sensors along the vehicle longitudinal axis are shown. The translational acceleration that applies to the entire vehicle 100 outside the crumple zone is also shown.

The movement of a rigid body can be broken down into a translation of any point of the body, advantageously the center of gravity, with a translational acceleration \vec{a}ₜᵣₐₙₛ, and into a rotation of the body about this point with a rotation rate vector \vec{ω}.

The translation does not necessarily have to take place in a specific fixed spatial direction, the trajectory of the translation can change its direction as a function of time-decisive for the term translation is only that the spatial orientation of the body does not change in the process. In a pure translation, the same acceleration is therefore present at each point of the body.

By definition, only translational accelerations prevail at the selected point through which the axis of rotation passes.

Rotational accelerations and centripetal accelerations also occur at points outside the rotation point. At the start of a vehicle crash, when the rotation caused by the crash is only beginning, the centripetal accelerations are low and can be neglected. A changing rate of rotation \vec{ω} (angular acceleration \dot{\vec{ω}}) generates at a location with the location vector \vec{r} measured from the rotation point, the rotational acceleration \vec{a}ᵣₒₜ=\dot{\vec{ω}}×\vec{r}, which points in the tangential direction (perpendicular to the location vector).

In summary, the following applies to acceleration at any location of the body

$$\vec{a} = {\vec{a}}_{trans} + {\vec{a}}_{rot} = {\vec{a}}_{trans} + \dot{\vec{ω}} \times \vec{r} . \qquad ( 1 )$$

In FIG. 2, the rotational vector field and the breaking down in x- and y-components are shown by way of example for the sensors of two PAS axes (distances r0 or r1 from the rotation point, angles α0 or α1 at the rotation point), and for sensors placed centrally along the longitudinal axis of the vehicle, which sensors are located at the same height along the vehicle longitudinal axis as the sensors on the PAS axis.

The following observation is also important here:

One can easily be persuaded that, in addition to the rotational acceleration, only the longitudinal component of the distance from the point of rotation is relevant for the magnitude of the lateral acceleration, i.e. distance times the sine of the angle. As a result, all sensors that are located at the same height along the vehicle longitudinal axis, e.g. both sensors on a PAS axis and sensors located between them, measure the same lateral (y-) component of the rotational and thus also of the entire acceleration, since the translational component is identical at all points anyway.

It also follows that for the longitudinal acceleration only the lateral distance from the rotation point is important, i.e. distance times the cosine of the angle. This has the consequence that, for example, all sensors on the left-hand vehicle periphery (e.g., front or rear PAS axes) measure the same longitudinal (x-) component of the rotational and thus also of the entire acceleration, since the translational component is identical at all points anyway.

In crashes without a rotational component, e.g., a front crash with full coverage and not at an angle, or side crashes centrally onto the vehicle center of gravity and not at an angle, the same purely translational accelerations occur outside the crumple zone at all measurement locations, of course apart from secondary effects resulting from the anisotropy of vehicles.

In crashes with rotational components, different resulting accelerations result at different locations in the vehicle. In the following, we will focus on lateral accelerations and take advantage the fact that their magnitude and direction (to the left or right) as explained above depend only on the position of the sensor along the vehicle longitudinal axis and that the lateral distance of the sensor from the vehicle longitudinal axis is not relevant. Without limiting generality, sensors arranged centrally along the vehicle longitudinal axis can thus be assumed.

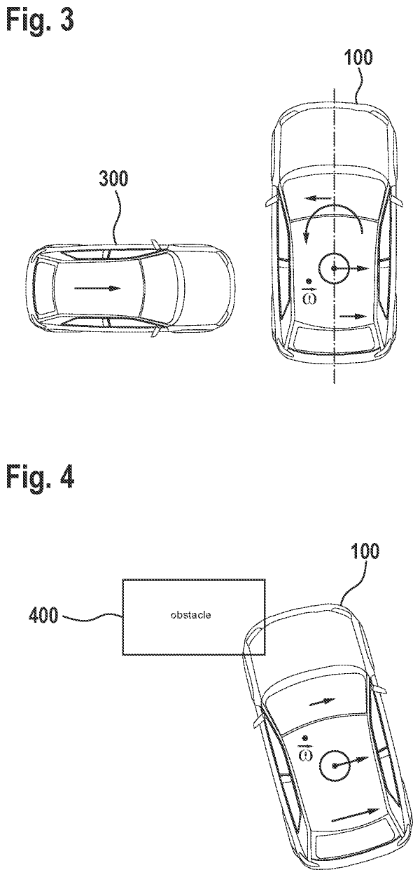

FIG. 3 shows a schematic representation of a side crash, a so-called “side off-zone crash,” in which the vehicle 100 is struck by a third-party vehicle 300.

By way of example, in FIG. 3 the side off-zone crash is shown at the rear left. This leads to a translation of the vehicle 100 to the right plus a rotation of the vehicle 100 in the counterclockwise direction:

At a measurement position close to the center of gravity or to the front occupants, essentially the translation to the right will measured.

In a measurement position in the rear vehicle region (PAS axis on the C-pillar, on the rear tunnel, rear sensors), translational and rotational accelerations superimpose constructively and a high acceleration to the right is obtained.

At a measurement position in the front vehicle region (e.g., an airbag controller located far forward on the engine bulkhead), translational and rotational accelerations superimpose destructively, the resulting acceleration can be close to zero or even point to the left.

Vehicles without sensors close to the center of gravity or to the front occupants are of particular interest. In such a case, the front sensor (e.g., control unit close to the engine bulkhead) measures a low acceleration, possibly even a left-pointing acceleration, the rear sensor measures a strong acceleration to the right. The approach described here now enables not only a reconstruction of the rotational acceleration (here counterclockwise), but also the actual movement of the center of gravity or of the occupants.

FIG. 4 shows a schematic representation of a front partial overlap crash, a so-called “front offset crash,” in which the vehicle 100 drives against an obstacle 400. A front offset crash on the left side is shown. The rotation about the point of impact resulting here can also be understood as a translation of the center of gravity of the vehicle or of a point in the region of the front occupants to the right plus a rotation in the counterclockwise direction about this point.

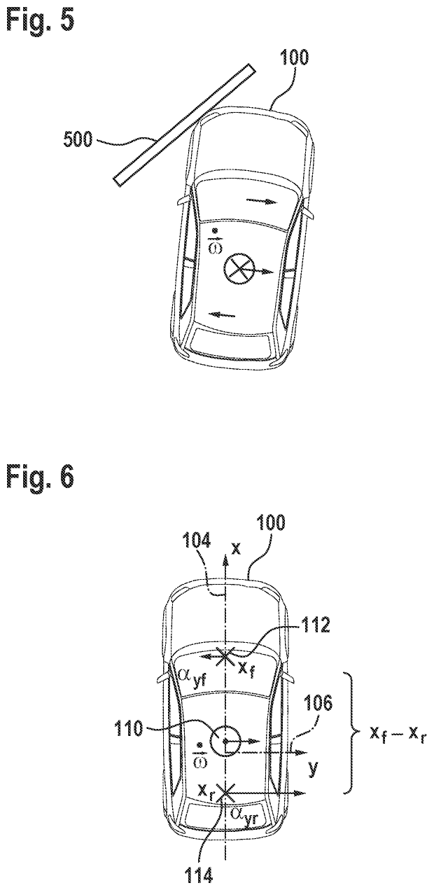

FIG. 5 shows a schematic representation of a front crash at an angle, a so-called “front angle crash,” in which the vehicle 100, for example, drives obliquely against a wall 500. A front angle crash on the left side is shown. By the front of the vehicle being pushed away to the right, a translation of the center of gravity or of a point in the region of the front occupants to the right, plus a clockwise rotation about this point, arises.

The approach described here makes it possible to correctly detect these movements and in particular the effect on the occupants if no sensor system is available near the vehicle center. In particular, this also allows a statement to be made about the translation of the central vehicle region.

FIG. 6 shows a schematic representation of a vehicle 100 according to one exemplary embodiment. Corresponding to FIG. 1, the vehicle axis 104, for example the x-axis, and the further vehicle axis 106, for example the y-axis, are shown, wherein the coordinate system with the x-axis and the y-axis has its origin at the position 110, i.e. at the point 0 whose acceleration is to be ascertained. This is, for example, the center of gravity of the vehicle 100 or a point in the region of the front occupants. The axis of rotation with the rotation rate vector \vec{ω}. also passes through this point. The following sign convention is used: rotation rates are positive in the counterclockwise direction, lateral accelerations are positive in the case of acceleration to the right.

In addition to the position 110 for which the acceleration is to be ascertained, the first location 112 and the second location 114 are shown. A front sensor is located at the first location 112 at the x-coordinate x_{f}. The front sensor measures a lateral acceleration a_{yf}. A rear sensor is located at the second location 114 on the on the x-coordinate xᵣ with a lateral acceleration a_{yr}. If the rear sensor is located behind the coordinate origin, as in the example in FIG. 6, the value of xᵣ will be negative. In this case x_{f} corresponds to the already mentioned first distance between the position 110 and the first location 112, and xᵣ corresponds to the already mentioned second distance between the position 110 and the second location 114.

From Eq. (1) this yields for the lateral accelerations at the front and rear measurement locations, here the locations 112, 114, and at the coordinate origin 0, here the position 110:

$${a}_{yf} = {a}_{y , trans} - \dot{ω} {x}_{f} \qquad ( 2 )$$

$${a}_{yr} = {a}_{y , trans} - \dot{ω} {x}_{r} \qquad ( 3 )$$

$${a}_{y 0} = {a}_{y , trans} - \dot{ω} {x}_{0} = {a}_{y , trans} \qquad ( 4 )$$

At the coordinate origin, here the position 110, since x₀=0 by definition no rotational but only a translational acceleration will occur.

Optionally, by forming the difference between (2) and (3), the rotational acceleration \dot{ω} can be ascertained:

$$\dot{ω} = \frac{{a}_{yr} - {a}_{yf}}{{x}_{f} - {x}_{r}} . \qquad ( 5 )$$

According to the approach described here, the lateral acceleration at point 0 is determined at point 0, a_{y0}=aₜᵣₐₙₛ, i.e. at the position 110. For this purpose, the equation (2) multiplied by xᵣ is subtracted from the equation (3) multiplied by x_{f}. Finally, we obtain

$${a}_{y , trans} = \frac{{x}_{f} {a}_{yr} - {x}_{r} {a}_{yf}}{{x}_{f} - {x}_{r}} = \frac{{x}_{f}}{{x}_{f} - {x}_{r}} {a}_{yr} - \frac{{x}_{r}}{( {x}_{f} - {x}_{r} ) {a}_{yf}} \qquad ( 6 )$$

This generally corresponds to a weighted averaging of the two measured accelerations a_{yr} and a_{yf},

$${a}_{y , trans} = {f}_{r} {a}_{yr} + {f}_{{fa}_{yf}} \qquad ( 7 )$$

wherein the weighting factors result from the longitudinal distances of the measurement locations from the coordinate origin at point 0. The sum of the two weighting factors is 1.

If the rear sensor is located behind the point 0, then xᵣ will be negative and thus both weighting factors positive:

$${f}_{r} = \frac{{x}_{f}}{{x}_{f} - {x}_{r}}$$

$${f}_{f} = \frac{- {x}_{r}}{{x}_{f} - {x}_{r}} = \frac{\vert {x}_{r} \vert}{{x}_{f} - {x}_{r}}$$

The weighting factor for the acceleration of the rear sensor, which was previously referred to as the second weighting factor, corresponds to the ratio between the longitudinal distance of the front sensor from the point 0 x_{f} and the longitudinal distance between the front and rear sensors x_{f}-xᵣ. In this case, x_{f} can represent the signed distance of the front sensor from the point 0, and xᵣ represent the signed distance of the rear sensor from the point 0.

The weighting factor for the acceleration of the front sensor, which was previously referred to as the first weighting factor, corresponds to the ratio between the longitudinal distance of the rear sensor from the point 0 |xᵣ| and the longitudinal distance between the front and rear sensors x_{f}-xᵣ.

If both measurement locations are located on one side of the origin, e.g. both sensors in front of point 0, i.e. x_{f} and xᵣ are positive, then the acceleration at the measurement location closer to the point 0, in this example therefore the rear measurement location, i.e., the second location 114, will be weighted with a positive weighting factor of >1 and the acceleration at the more distant measurement location will be weighted with a negative weighting factor.

In summary, the lateral acceleration at the location 0, i.e. the position 110, is obtained from a weighted summation of a front and a rear lateral acceleration. This lateral acceleration is provided for further use, for example, by using the already mentioned output signal.

The front or rear lateral accelerations at the locations 112, 114, which are provided, for example, via the input signals already mentioned, can either represent direct measurement values of a sensor, which is located centrally on the vehicle axis 104, here by way of example on the vehicle longitudinal axis, or signal values derived from the measured values, possibly from a plurality of sensors on the left or right of the vehicle longitudinal axis. As described above, the lateral distance of the sensor from the vehicle longitudinal axis is irrelevant. For example, the front lateral acceleration can be derived from a central control unit arranged centrally or offset, or from the measured values of a front PAS axis, e.g., on the A- or B-pillar. In the latter case, for example, an averaging or a maximum formation from the two PAS sensor measured values can take place, or the side facing the crash or the side facing away from the crash can be selected. The rear lateral acceleration can be derived in a similar manner, for example from the measured values of a rear PAS axis, for example on the C-pillar or in the rear region.

According to one exemplary embodiment, the front and rear lateral accelerations are also suitably preprocessed, e.g. filtered, in order to thereby obtain a processed acceleration at the location 0, i.e., the position 110.

According to the present invention, this method can also be transferred to longitudinal accelerations: the longitudinal acceleration at a desired point can be derived from the longitudinal acceleration a_{xL} of a left-hand sensor and of a right-hand sensor a_{xR} taking into account the lateral distances of the left-hand and right-hand sensors from the vehicle center (y_{L} or y_{R}, positive values for positions to the right of the center, negative to the left):

$${a}_{x , trans} = \frac{{y}_{R} {a}_{xL} - {y}_{L} {a}_{xR}}{{y}_{R} - {y}_{L}} = \frac{{y}_{R}}{( {y}_{R} - {y}_{L} ) {a}_{xL}} - \frac{{y}_{L}}{{y}_{R} - {y}_{L}} {a}_{xR} \qquad ( 8 )$$

In the normal case, a left-hand sensor will also be located to the left of the center (y_{L} negative) and a purely right-hand sensor will also be located to the right of the center (y_{R} positive), and generally these positions will also be arranged symmetrically in relation to the vehicle center (y_L=−y_R). Then (8) simplifies into a simple averaging of the left-hand and right-hand sensor signals:

$${a}_{x , trans} = \frac{{a}_{xL} + {a}_{xR}}{2}$$

Eq. (8) however also applies more generally; for example, both sensors can also be arranged on one side of the vehicle center, e.g. a control device, which is not centrally placed in a lateral direction, in a BEV vehicle without a central tunnel together with a PAS sensor. Since the longitudinal signal, as explained above, depends only on the lateral distance from the vehicle center, these two sensors do not have to be located at the same height along the vehicle longitudinal axis.

The acceleration ascertained at a point different from the measurement locations can in principle be used, where today the accelerations of the central control unit are used—they can replace or supplement the measured accelerations of the control unit. This applies in particular when the airbag controller is not located centrally, e.g., far forward, and does not detect the accelerations in the region of the center of gravity or of the occupants, or when there is no central control device at all.

For example, for the recognition of side crashes, especially side off-zone crashes, or for the recognition of lateral components in front crashes, the lateral acceleration ascertained (6) or (7) or a feature derived therefrom can be used.

The ascertained longitudinal acceleration (8) or a feature derived therefrom can be used to recognize front crashes. This can in particular be relevant for BEV vehicles without a central tunnel and a laterally non-centrally positioned control device.

Reconstructed accelerations at different locations can also be used for an optimized control of restraint means. For example, lateral accelerations (6) or (7) can thus be calculated separately for each row of seats. In a side off-zone crash, as shown in FIG. 3, a significantly greater lateral acceleration results, for example in the region of the rear occupants than in the region of the front occupants. In this way, further or other restraint means can be controlled specifically for rear occupants than for front occupants.

It is particularly advantageous to combine the acceleration thus ascertained with an additionally ascertained rotational acceleration, e.g., Eq. (5). The rotational acceleration can thereby be provided by using the rotation signal already mentioned. For example, the recognition of side off-zone crashes can be determined by a combined evaluation of the rotational acceleration (5) or of a feature derived therefrom and of the acceleration reconstructed at a suitable point according to Eq. (6) or (7) or of a feature derived therefrom. Such a combined evaluation can be, for example, a rounding of threshold-value queries relating to both features (5) and (6)/(7), or a characteristic curve in a 2-dimensional feature space, in which features based on the rotational acceleration (5) and features based on the reconstructed acceleration (6)/(7) are plotted against one another.

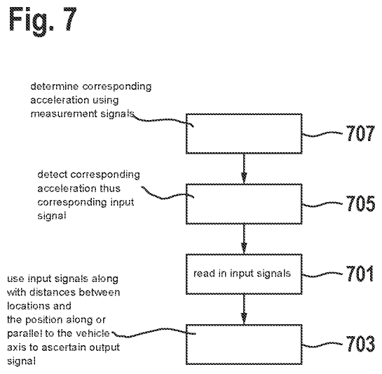

FIG. 7 shows a flowchart of a method according to an exemplary embodiment. The method enables an ascertainment of an acceleration prevailing in a vehicle, as described, for example, with reference to FIGS. 1 and 6.

In order to ascertain a corresponding acceleration at a position of the vehicle, in a step 701 input signals are read in, which input signals represent accelerations acting transversely to a vehicle axis at different locations in the vehicle. According to one exemplary embodiment, the locations are located on the vehicle axis and are at a distance from the position. The vehicle axis can be, for example, an axis running longitudinally or running transversely through the vehicle; correspondingly the accelerations sensed transversely thereto are lateral or longitudinal accelerations. Such an axis can run through the center of gravity of the vehicle or outside the center of gravity.

In a step 703, the input signals along with distances between the locations and the position along or parallel to the vehicle axis are used to ascertain an output signal which represents a translational acceleration which is acting transversely to the vehicle axis at the position.

According to an exemplary embodiment, a sum is formed for this purpose from the accelerations multiplied by weighting factors. The weighting factors are in turn determined by using the distances of the locations from the position. For example, a first weighting factor assigned to the first location is determined as the quotient of the first distance of the first location from the position and a difference between the first distance and the second distance of the second location from the position. Accordingly, a second weighting factor assigned to the second location is determined as the quotient of the second distance and a difference between the first distance and the second distance.

If an acceleration sensor is arranged at the locations or at least at one of the locations, according to an exemplary embodiment, in an optional step 705, the corresponding acceleration and thus the corresponding input signal will be detected by using the corresponding acceleration sensor.

If no acceleration sensor is arranged at the locations or at least at one of the locations, according to an exemplary embodiment, in an optional step 707, the corresponding acceleration will be determined by using measurement signals which represent accelerations acting transversely to the vehicle axis at different sensor locations in the vehicle that are located outside the vehicle axis. In this way, an acceleration acting at one of the locations can be determined, although no acceleration sensor is arranged at this location.

According to an exemplary embodiment, in the step 703 of ascertaining, a rotation signal is optionally ascertained, which represents a rotational acceleration which is acting at the position about an axis of rotation oriented orthogonally to the vehicle axis. The rotational acceleration is also ascertained by using the first input signal, i.e. the acceleration at the first location, the second input signal, i.e. the acceleration at the second location, along with the first distance and the second distance. For example, the rotation signal is ascertained as a quotient of a difference from the second acceleration acting at the second location, and the first acceleration acting at the first location, as well as from a difference between the first distance and the second distance.

According to one exemplary embodiment, in the read-in step 701, further input signals are read in, which represent further accelerations which at locations lying on another axis are acting transversely to the other axis. These further input signals are used in a corresponding manner with the distances applicable to these locations in order to ascertain an acceleration at the position already mentioned or at another position of the vehicle in a corresponding manner.

What is claimed is:

1. A method for ascertaining an acceleration prevailing in a vehicle, the method comprising the following steps:
reading in a first input signal representing a first acceleration acting transversely to a vehicle axis of the vehicle at a first location in the vehicle located on the vehicle axis, and a second input signal representing a second acceleration acting transversely to the vehicle axis at a second location in the vehicle located on the vehicle axis;
ascertaining an output signal representing a translational acceleration acting transversely to the vehicle axis at a position in the vehicle, which position differs from the first location and the second location, by using the first input signal, the second input signal, a first distance along the vehicle axis between the first location and the position, and a second distance along the vehicle axis between the second location and the position.

2. The method according to claim 1, further comprising:
detecting the first input signal by using a first acceleration sensor arranged at the first location and/or detecting the second input signal by using a second acceleration sensor arranged at the second location.

3. The method according to claim 1, further comprising:
determining the first input signal by using at least two first measurement signals which represent accelerations acting transversely to the vehicle axis at different first sensor locations in the vehicle lying outside the vehicle axis and/or determining the second input signal by using at least two second measurement signals which represent accelerations acting transversely to the vehicle axis at different second sensor locations in the vehicle located outside the vehicle axis.

4. The method according to claim 1, wherein in the ascertaining step, the output signal is ascertained from a sum of the first acceleration multiplied by a first weighting factor and the second acceleration multiplied by a second weighting factor, wherein the first weighting factor and the second weighting factor are determined by using the first distance and the second distance.

5. The method according to claim 4, wherein the first weighting factor is determined as a quotient of the first distance and a difference between the first distance and the second distance, and the second weighting factor is determined as a quotient of the second distance and a difference between the first distance and the second distance.

6. The method according to claim 1, wherein in the ascertaining step, a rotation signal is ascertained which represents a rotational acceleration acting at the position about an axis of rotation oriented orthogonally to the vehicle axis, by using the first input signal, the second input signal, the first distance, and the second distance.

7. The method according to claim 6, wherein in the ascertaining step, the rotation signal is ascertained as a quotient of a difference between the second acceleration and the first acceleration and of a difference between the first distance and the second distance.

8. The method according to claim 1, wherein, in the reading in step, a third input signal is read in, which represents a third acceleration acting at a third location in the vehicle transversely to a further vehicle axis which is oriented orthogonally to the vehicle axis, and a fourth input signal is read in, which represents a fourth acceleration acting transversely to the further vehicle axis at a fourth location in the vehicle located on the further vehicle axis, and wherein in the ascertaining step, a further output signal is ascertained, which represents a translational acceleration acting transversely to the further vehicle axis at a further position in the vehicle different from the third location and the fourth location, by using the third input signal, the fourth input signal, a third distance along the further vehicle axis between the third location and the further position and a fourth distance along the further vehicle axis between the fourth location and the further position, and a fourth distance along the further vehicle axis between the fourth location and the further position, wherein the further position and the position are identical or different.

9. A device configured to ascertain an acceleration prevailing in a vehicle, the device configured to:
read in a first input signal representing a first acceleration acting transversely to a vehicle axis of the vehicle at a first location in the vehicle located on the vehicle axis, and a second input signal representing a second acceleration acting transversely to the vehicle axis at a second location in the vehicle located on the vehicle axis;
ascertain an output signal representing a translational acceleration acting transversely to the vehicle axis at a position in the vehicle, which position differs from the first location and the second location, by using the first input signal, the second input signal, a first distance along the vehicle axis between the first location and the position, and a second distance along the vehicle axis between the second location and the position.

10. A non-transitory machine-readable storage medium on which is stored a computer program for ascertaining an acceleration prevailing in a vehicle, the computer program, when executed by a computer, causing the computer to perform the following steps:
reading in a first input signal representing a first acceleration acting transversely to a vehicle axis of the vehicle at a first location in the vehicle located on the vehicle axis, and a second input signal representing a second acceleration acting transversely to the vehicle axis at a second location in the vehicle located on the vehicle axis;
ascertaining an output signal representing a translational acceleration acting transversely to the vehicle axis at a position in the vehicle, which position differs from the first location and the second location, by using the first input signal, the second input signal, a first distance along the vehicle axis between the first location and the position, and a second distance along the vehicle axis between the second location and the position.
